(19) United States
(12) Patent Application Publication
(10) Pub. No.: US 2007/0000704 A1
(43) Pub. Date: Jan. 4, 2007

(54) Power supply device, particularly for a motor vehicle

(75) Inventor: Jurgen Mertens, Paderborn (DE)

Correspondence Address: BROWDY AND NEIMARK, P.L.L.C.;624 NINTH STREET, NW, SUITE 300, WASHINGTON, DC, 20001-5303, US

(73) Assignee: Icemaster GmbH Generatoren und Kaltetechnik, Paderborn (DE)

(21) Appl. No.: 11/414,555

(22) Filed: May 1, 2006

(30) Foreign Application Priority Data
Apr. 29, 2005 (DE) 10 2005 020 031.1

(51) Int. Cl. B60K 1/00

(52) U.S. Cl. 180/65.4

(57) ABSTRACT

The invention relates to a power supply device, particularly for a motor vehicle, with an internal combustion vehicle engine (FM), actuating a first rotary current generator (DG1) and a internal combustion supply engine (VM), actuating a second rotary current generator (DG2), whereby a controlled alteration switch (BS) connects the rotary current generator (DG1, DG2), which is currently in operation, to a first voltage converter (K1), topping a secondary converter (K2), the output voltage (UB) of which feeds low-voltage consumers (V) and an accumulator battery (AB), characterized in that the first voltage converter (K1) is a direct-voltage generator with solid-state circuit elements (MOS), which is polyphase high-frequency pulse-length regulated, generating an intermediate direct voltage (UG), which is converted to the low output voltage (UB) by the second voltage converter (K2), a direct-voltage regulator with a solid-state circuit element (MOS1), which is high-frequency pulse-length regulated.

The invention relates to a power supply device, particularly for a motor vehicle, with an internal combustion vehicle engine actuating a first rotary current generator, and a internal combustion supply engine actuating a second rotary current generator, whereby a controlled alteration switch connects the rotary current generator, which is currently in operation, to a first voltage converter, topping a secondary converter, the output voltage of which feeds low-voltage consumers and an accumulator battery.

A such power supply device is well-known from the DE 198 04 693 A1. Here the first converter, which is fed by the rotary current, consists of a three-phase transducer, which furnishes a three-phase voltage regulation over a high tension and frequency range, which results from the usually changing rotational speed of the vehicle engine. Such a transducer has a high weight and has a substantial space requirement, and needs means to carry off heat, since it has considerable copper and iron losses. Downstream of the transducer a transformer was placed, transforming a stabilized intermediate alternating voltage to an extra-low voltage, which likewise has iron and copper losses and has substantial space requirement and a high weight. The second rotary current generator was, as usual, provided with a field winding coil, which likewise brings about losses and requires space.

It is the object of the invention to design the aforementioned power supply device substantially smaller and with lower loss.

The object is met in such a way that the first voltage converter is a direct-voltage generator with solid-state circuit elements, which is polyphase high-frequency pulse-length regulated, generating an intermediate direct voltage, which is converted to the low output voltage by the second voltage converter, a direct-voltage regulator with a solid-state circuit element, which is high-frequency pulse-length regulated.

Advantageous embodiments of the invention are indicated in the subclaims.

The application of converters with solid-state circuit elements, which are regulated in high-frequency pulse-pause-operation, substantially reduces the required space, the weight and the power loss. In addition, the first converter serves as a polyphase rectifier, by which the intermediate voltage is furnished as a direct current, so the second converter can be a simple direct current to direct current transformer.

Preferably, both converters are assembled with fast switching low-loss MOS-FET power transistors, which are connected in series with filter inductors. Since the switching frequency of the governor regulating voltage is for example 20 kHz, these filter chokes are relatively small. They are wired to fast recovery diodes, so current is subsequently supplied also in the switching pauses. The control pulses are supplied in phase so the rectification is achieved.

The generator, which is equipped with a permanent magnetic field, has a small outline and no field inductor loss, has a great advantage. It is driven by the supply engine, according to power need and its rotational speed controlled,-whereby the rotational speed is chosen in such a manner, that the first converter is supplied with a high potential, via the intermediate voltage, matching the actual current consumption, and thus operates at a very low loss. The governors are advantageously realized by means of a microprocessor.

The consumer current is continuously metered when the vehicle engine stands still and the supply generator is switched on. If the current demand is high, and the charge of the accumulator is low, a starter current turns on the engine, preferably a diesel engine, the rotational speed of which is then controlled during operation.

The complete electronic unit with both converters and the voltage regulators and speed governors is advantageously placed in a housing.

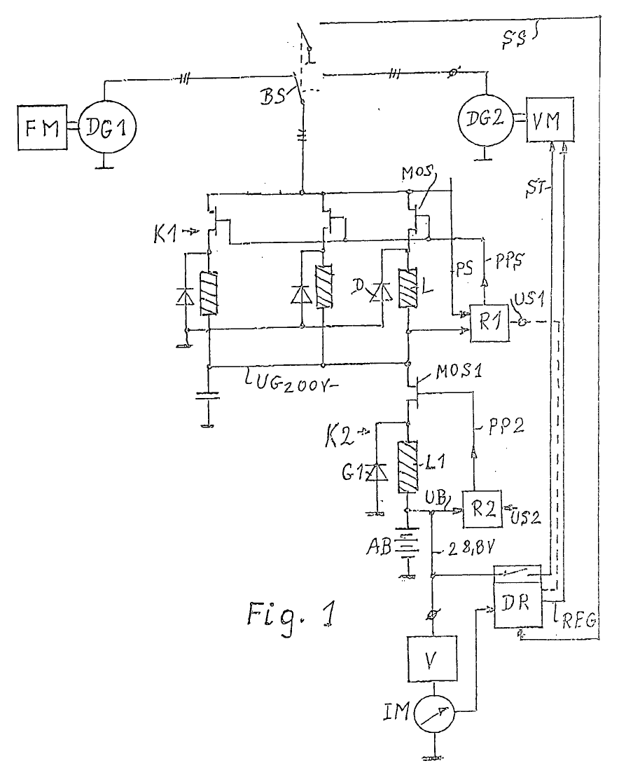

An advantageous embodiment is shown in FIG. 1

FIG. 1 indicates a power supply device, which is fed by, on one hand, a first rotary current generator DG1 with a vehicle engine FM, and, on the other hand, if the operating switch BS is turned over, by a second rotary current generator DG2 with a supply engine VM.

The three phases are supplied to a first converter K1 by the operating switch BS. The said converter contains MOS-FET power switches MOS for the three phases, or according to its outline/Model, also for six phases. These are connected in series with filter chokes L which, interconnected at the outlet, deliver an intermediate direct voltage UG. The chokes L are wired to recovery diodes D. The MOS-FET switches MOS are triggered, clocked in the right phase by means of a phasing signal PS at a frequency of about 20 kHz, whereby each pulse-pause-relation is determined by a regulator signal PP1 first in a group. The first regulator R1 compares the intermediate direct voltage UG to a preset first nominal voltage US1, which advantageously amounts to in between 150 and 250V, and preferably amounts to 220V. So the generator voltage, which can be as high as 800V peak voltage, is converted to this low voltage UG. The intermediate direct voltage UG is advantageously maintained by a filter capacitor C.

The generator voltage of the first generator DG1 varies, like the generator frequency, in a wide range, dependent on the actual rotational speed of the engine which is determined by the operation of the vehicle.

The second generator DG2 is also operated at a changing rotational speed; the number of revolutions however is controlled depending on the current consumption, in order to meet the demand. The current consumption is metered by a current meter IM at the consumer V and thus indicated to a speed governor DR, which controls the supply of the supply engine VM with a speed governor signal REG.

Depending on a switch position signal SS of the operating switch BS, the speed governor DR connects a starter current ST to the starter of the supply motor S, if a current demand is signalled, which can be met by an accumulator AB only for a limited time.

The accumulator battery AB is charged by means of a second voltage converter K2 with a battery charging voltage UB, which is taken out of the intermediate direct voltage UG, which is also supplied to the consumers V. Preferably, the accumulator has a nominal voltage of 24V and the battery charging voltage correspondingly amounts to 28.8V. This charging voltage UB is produced by means of a second voltage regulator R2 by a second nominal voltage of 28.8V; by supplying a matching 2^{nd} pulse-pause-signal PP2 to a MOS-FET switch MOS1 in the second converter K2. The MOS-FET-transistor MOS1 feeds the accumulator AB via a filter choke L1. Said filter choke L1 is wired to a recovery diode G1.

If, during supply operation, only a medium current demand prevails, the intermediate direct voltage UG, in another embodiment, is lowered by presetting the first nominal voltage US1 dependent on consumption, thus minimizing the general loss of both converters, as symbolized by the dashed line connecting the speed governor DR to the first voltage regulator R1.

According to the power outline of the complete device, and the solid-state-components available in each case, the converters are to be designed with parallel breaks, which preferably are operated with phase-quadrature pulse-control-signals, so a nearly continuous current flows with only minor interferences occur, which are released by radiation and are passed on to the consumers. Remaining ripples are to be removed from the direct voltage UG, UB by usual filter means, which are to be dimensioned relatively small due to the high clock frequency.

### REFERENCE SYMBOLS

AB accumulator battery
BS operating switch
C capacitors
DG1 1^{st} rotary current generator
DG2 2^{nd} rotary current generator
DR speed governor
FM vehicle engine
L filter choke
D1 choke
G1 rectifier
IM current meter
K1 1^{st} converter
K2 2^{nd} converter
MOS, MOS1 Mosfet-transistors
PP1, PP2 pulse-pause-signals 1 and 2
PS phase signal
R1, R2 1^{st} and 2^{nd} voltage regulator
REG speed governor signal
ST starter signal
SS switch position signal
UG intermediate direct voltage
UB battery voltage
US1, US2 1^{st} and 2^{nd} nominal voltage
V low-voltage consumer
VM supply engine

1. Power supply device, particularly for a motor vehicle, with an internal combustion vehicle engine (FM), actuating a first rotary current generator (DG1) and a internal combustion supply engine (VM), actuating a second rotary current generator (DG2), whereby a controlled alteration switch (BS) connects the rotary current generator (DG1, DG2), which is currently in operation, to a first voltage converter (K1), topping a secondary converter (K2), the output voltage (UB) of which feeds low-voltage consumers (V) and an accumulator battery (AB), characterized in that the first voltage converter (K1) is a direct-voltage generator with solid-state circuit elements (MOS), which is polyphase high-frequency pulse-length regulated, generating an intermediate direct voltage (UG), which is converted to the low output voltage (UB) by the second voltage converter (K2), a direct-voltage regulator with a solid-state circuit element (MOS1), which is high-frequency pulse-length regulated.

2. Power supply device according to claim 1, characterized in that the intermediate direct voltage (UG) is supplied as an actual voltage to a first voltage regulator (R1), to which is also supplied a first nominal voltage (US1) and a phasing signal (PS) from the generator voltage, and the output of which supplies first high-frequency pulse-pause control signals (PP1) in the right phase to the solid-state circuit elements (MOS).

3. Power supply device according to claim 2, characterized in that the first nominal voltage (US1) is preset to between 150V and 250V.

4. Power supply device according to claim 2, characterized in that the solid-state circuit elements (MOS) are MOS-FET-transistors which are interconnected to and triggered as a polyphase rectifier, and are wired to a filter choke (L) and a recovery diode (D), and that the intermediate direct voltage (UG) is maintained by a capacitor (C).

5. Power supply device according to claim 1, characterized in that the low-voltage output voltage (UB) is supplied as an actual voltage to a second voltage regulator (R2), to which is supplied a second nominal voltage (US2) and the output of which supplies second high-frequency pulse-pause control signals (PP2) to the solid-state circuit element (MOS1).

6. Power supply device according to claim 5, characterized in that the second nominal voltage (US2) amounts to 28.8V and that the accumulator battery (AB) has a nominal voltage of 24V.

7. Power supply device according to claim 5, characterized in that the second solid-state circuit element (MOS1) is a MOS-FET-transistor, which is connected in series with a filter choke (L1), which is wired to a recovery diode (G1).

8. Power supply device according to claim 1, characterized in that the second rotary current generator (DG2) possesses a permanent magnetic field, and the corresponding supply engine (VM) is a diesel engine, the rotational speed of which is controlled, and the consumers (V) are connected to the accumulator battery (AB) via a current meter (IM), the current meter signal of which is supplied to a speed governor (DR), which effects a load-controlled regulation of the rotational speed of the supply engine (VM), so the converter (K1) produces a minimum loss.

9. Power supply device according to claim 8, characterized in that a switch position signal (SS) is supplied to the speed governor (DR), indicating when the alteration switch (BS) has connected the second rotary current generator (DG2), and, whenever the present current consumption can only be supplied by the accumulator battery (AB) for a limited time, the speed governor (DR) supplies a starter current (ST) from the accumulator battery (AB) to the supply engine (VM), until the latter starts running.

10. Power supply device according to claim 9, characterized in that the speed governor (DR) and the voltage regulators (R1, R2) consist of at least one microprocessor.

11. Power supply device according to claim 8, characterized in that the speed governor (DR) supplies a first nominal voltage (US1) to the first voltage regulator (R1), which is chosen depending on the rotational speed in such a way that the general total loss of both converters (K1, K2) is in each case minimal.

12. Power supply device according to claim 1, characterized in that several second converters can be connected in a modular parallel manner.

13. Power supply device according to claim 8, characterized in that the converters (K1, K2) and the regulators (DR, R1, R2) are combined to and mounted as a replaceable unit.
